(19) United States
(12) Patent Application Publication
(10) Pub. No.: US 2014/0290798 A1
(43) Pub. Date: Oct. 2, 2014

(54) Triple cutter router bit

(71) Applicant: David Hilker, San Jacinto, CA (US)

(72) Inventor: David Hilker, San Jacinto, CA (US)

(21) Appl. No.: 13/986,113

(22) Filed: Apr. 2, 2013

(51) Int. Cl. B27G 13/14

(52) U.S. Cl. CPC B27G 13/14
USPC 144/219

(57) ABSTRACT

The router bit includes an upper and a lower cutter, axially aligned and separated by a fixed longitudinal displacement. No substantial portion of the bit extends beyond the lower end of the lower cutter. In some embodiments, the lower cutter may be configured with bottom face blades to allow the router to be used as a plunging bit. The cutters may use wing blades or spiral blades. The portion of the bit intervening between the upper and lower cutters may also be configured as a cutter. In some embodiments, the router bit is integral. In other embodiments, it comprises separate elements that may be axially secured.

### CROSS-REFERENCE TO RELATED APPLICATION

This is a Division of application Ser. No. 11/654,128.

### BACKGROUND OF THE INVENTION

1. Field of the Invention

This invention relates to the field of woodworking and, in particular, cabinet making.

2. Description of Prior Art

Skilled craftsmen have built fine cabinetry since the dawn of history. Over the millennia, steady improvements in cabinet design and execution have transformed what originally was merely utilitarian manufacture into a recognized and admired art form. Museums, everywhere, display superb examples of the cabinetmaker's art, and examples of Seventeenth and Eighteenth Century cabinets and other furniture pieces from noted artists often command huge prices at auction.

However, development of the structural aspects of cabinetmaking has not entirely kept pace with the skill of woodworkers and the exacting artistic and decorative requirements of those willing to pay substantial sums for their finest products. Crudely made cabinets, often seen installed in kitchens and closets, commonly utilize simple butt joints, i.e., abutting parts are nailed or stapled together, and typically glued, without formed joints. Better construction may utilize dowel joints or the dado/rabbet joint. However, it is believed that the best construction method for use with cabinet and drawer body panels, utilizing modern materials and machinery, would be the “mortise and tenon” or the “tongue and groove” joint. But all of these various types of joint continue to be utilized today, differing little from their predecessors of hundreds of years ago, and practitioners of ordinary skill understand them and are familiar with their respective positive and negative features.

To be sure, the materials employed have changed substantially. Better adhesives ensure that glued joints will remain rigid for many years. Screws, nails and staples have been greatly improved and can now be power driven. Also, it is well recognized that solid wood, in addition to its expense, may not be the best material available for cabinet and drawer body structures, as it tends to swell, shrink and warp over time, even if well seasoned before use. Veneer has been used for centuries for intricate inlay work, to increase panel stability and to reduce cost. Furthermore, veneer can convert a relatively inexpensive substrate, e.g., particleboard, into what appears to be a finely figured piece of solid wood.

Most cabinet bodies and a large proportion of drawer bodies are now made from plywood, particleboard or fiberboard—such as “MDF” (medium density fiberboard)—surface bonded with, e.g., polymerized melamine, laminate plastic or a suitable wood veneer. These bonded materials are typically supplied in 4 foot by 8 foot rectangular panels, although other sizes are also generally available, and such panels of whatever size will herein be referred to, generically, as “sheet stock.”

Cabinets and drawer bodies are preferably assembled with some type of joint, normally nailed/stapled or screwed together, but they may also be glued if desired. However, plywood, particleboard and fiberboard substrates, whether or not surface bonded with a laminated wood veneer or plastic, do not lend themselves readily to some traditional joinery techniques, because the shape of such joints, when used with these materials, may easily cause the material to fracture or even crumble when the pieces are assembled, or the tolerances of such a joint must necessarily be so wide that the essential purpose of the joint is defeated. Examples of such joints would be: lock miter, lock shoulder, finger dovetail and French dovetail.

Using a kitchen cabinet with a door, four sides, a back and a shelf as an example, the four sides, shelf and back can be cut from sheet stock, essentially by sawing to size the desired outline of each particular part. After sawing, formed joints may be further machined onto selected edges of certain parts using a variety of traditional cutters well known in the art.

Typical router bits used for these purposes and related usages are described abundantly in the literature. Reference can, for example, be made to the following U.S. patents, which are only a few of the many describing these time-honored procedures and their variations and related arts: U.S. Pat. No. 283,678 (Steele, 1883); U.S. Pat. No. 607,394 (Hatch, 1898); U.S. Pat. No. 984,407 (Wolvin, 1911); U.S. Pat. No. 1,370,895 (Loomis, 1921); U.S. Pat. No. 1,748,767 (Heston, et al.); U.S. Pat. No. 3,008,501 (Hammer, 1961); U.S. Pat. No. 5,316,061 (Lee, 1994); U.S. Pat. No. 5,433,563 (Velepec, 1995); U.S. Pat. No. 5,899,252 (Pozzo, 1999); and U.S. Pat. No. 5,996,659 (Burgess, 1999). To be sure, these all represent steps in the progressive evolution of the cabinetmaking art. But they do not effectively solve many significant problems specifically addressed and solved by the present router bit, to be described below, in detail.

With the possible exception of very small scale manufacturers, cabinetmakers now tend increasingly toward mechanization of processing steps, often utilizing computer controlled equipment. Two types of “CNC” (computer numeric controlled) machinery are commonly used, today, to process sheet stock efficiently. These may be compared and contrasted as follows:

In point-to-point processing, the work piece is first cut from sheet stock by a saw and then placed on small (square or round, typically about 4 inches across) “vacuum pods,” which are supports on which the work pieces are held on the machine by a strong vacuum. Multiple vacuum pods are positioned to adequately support and secure the work piece (whose size may vary greatly), and to elevate it above the machine's work table. In this position, the machine is able to position a cutter correctly to form a joint on the edge of the work piece.

The router bit described in U.S. Pat. No. 6,367,524 (Brewer, 2002: “the '524 patent”), which cites the foregoing patents and several publications, might be effective in such a point-to-point environment because its locking nut 32 and associated structures would be positioned below the work piece, due to its elevation above the work table on one or more vacuum pods, and they would not, therefore, impinge on the workpiece or the work table. But if the '524 router bit were used with a point-to-point CNC machine, the pilot ball bearing 24 would probably need to be removed and replaced with shims 26, as identified in that patent.

However, the '524 bit appears not to have been intended for use in a point-to-point CNC machine, but rather with hand held router motors and manual routing machines, where the shape of the work piece, itself, would serve as the pattern against which the pilot ball would ride. Variations of the '524-type router bit have been used with a separate jig or fixture, which is used to hold the work piece, as well as to guide the pilot ball bearing. Still other variations of the '524-type router bit have been used with guide pins and/or fences instead of the pilot ball bearing 24.

Of the two types of CNC machines now utilized, point-to-point manufacturing more closely resembles traditional woodworking methods and, therefore, can more easily utilize existing cutters, such as '524-type router bits.

The other type of CNC woodworking machine is referred to as a nested based machine. With this machine, the full (e.g., 4 foot by 8 foot) sheet stock is placed atop a “spoil board” on the machine's work table. A spoil board is a rectangular panel of fiberboard, the same size as the sheet stock, used to protect the machine's work table by allowing the various tools to cut through the sheet stock and slightly into the spoil board (typically, in the order of 0.007 inch). A nested based CNC machine delivers vacuum over the entire work table, which is typically 4 feet by 8 feet in size, but which, like sheet stock, can be of a different size. Because fiberboard is porous, the suction created by the vacuum pulls through the spoil board, into the sheet stock. This firmly secures and flattens the entire surface of the sheet stock to the spoil board and, thus, to the work table. Work pieces are cut from the sheet stock in what resembles a jig saw puzzle, referred to as a “nest.” As work pieces are cut from successive pieces of sheet stock, a pattern of shallow impressions will be cut into the spoil board, and the spoil board will eventually need to be resurfaced or replaced.

Certain problems are commonly encountered in nested based CNC operations, particularly where tenon formation on work piece edges, in situ, is desired. Typically:

The work pieces are all in close proximity to one another, generally less than ¾ inch apart, requiring a very small router bit that will not break at high feed rates, when forming an edge joint.

The work pieces are all in the same plane. Since none of the work pieces are elevated, access to the edges of a particular work piece is severely restricted by the close proximity of the adjacent work pieces in the nest.

The work pieces are held firmly against the spoil board, which is, in turn, held firmly against the machine's vacuum work table. This lack of intervening space restricts the router bit's ability to be correctly positioned vertically.

As the router bit moves around the edges of the various work pieces in the nest, forming tenons, the router bit must be able to drill down into the sheet stock and spoil board, thereby cutting its own channels or paths of travel. I.e., in a CNC nested based application, the router bit must “plunge cut” (vertically) and bottom cut, as well as “edge cut” (horizontally).

In general, sheet stock is available with one good face, intended for the exterior of the cabinet, and one lesser face, intended for the cabinet interior. The router bit needs to form tenons on the edges of the work pieces in the nest with the exterior face of the sheet stock oriented downward and the interior face upward, to facilitate additional machining of the work pieces—e.g., boring for adjustable shelf holes, cutting mortises for partitions and fixed shelves, and forming dado for backs and drawer bottoms—without removing them from the nest, for optimal automation.

The thickness of sheet stock varies by as much as ±0.032 inch from batch to batch, between panels in the same batch and among various locations within a given panel. Since the sheet stock is positioned on the work table with the interior face up, positioning of the resulting tenons in respect to the exterior (bottom) face is extremely important, to ensure that any visual or mechanical imperfections resulting from such thickness variations appear on the upper surface of the work pieces, i.e., in the cabinet interior, where they will be unimportant.

Finally, the router bit must form clean tenons without chipping either the interior or exterior faces of the work pieces. This requires use of a “compression cut,” whereby shear cutting forces the upper surface of the work piece downward and oppositely oriented shear cutting simultaneously forces the lower surface upward. Compression bits, per se, are, of course, well known in the art.

However, neither the '524 bit nor any other router bit in the prior art solves or even addresses the remaining six problems cited above in such a CNC nested based environment.

For example, the prior method of dealing with sheet stock of varying thickness has been to precisely measure the thickness of each sheet stock panel at various locations, to attempt to exactly position the tenons on the various edges of the resulting work pieces. Clearly, this requires a great deal of time, effort and expense, without providing any guarantee of success. The usual result is that the problem is simply ignored, yielding cabinets in which panels do not join securely or must be forced together, and/or joints that are misaligned because one panel is offset from the adjoining panel. In fact, all of these errors frequently occur. One need only carefully inspect a relatively small number of kitchen cabinets to observe this.

As stated above, nested based CNC manufacturing requires router bits capable of plunge cutting into the sheet stock, and then bottom cutting and linear cutting . . . in situ. In that environment, the '524 router bit will not plunge or bottom cut, because its locking nut 32 and associated structures are in the way. If channels could be cut into the sheet stock and spoil board so that the '524 router bit did not need to plunge or bottom cut, its locking nut and associated structures would still impinge upon the spoil board, improperly positioning the cutting blades. Indeed, there is apparently no way for an adjustable router bit such as described in the '524 patent to be employed in a nested based manufacturing operation. Clearly, therefore, the '524 bit is applicable only to point-to-point and manual manufacturing, and is wholly impractical in a nested based application, where the spoil board must be flush with the lower surface of the sheet stock to hold vacuum.

Furthermore, the '524 bit uses the outer bearing race to guide the bit as it moves along the edge of the work piece, cutting the tenon. However, there are some circumstances where it might be desirable for the portion of the router bit that impinges on the tenon edge as a guide to be able to trim that edge as the tenon is cut. Such a third-position cutter is not taught in the '524.

Finally, the adjustment principle, which is the salient feature of the '524 patent, has little application in CNC nested based manufacturing, where accuracy, consistency and repeatability are crucial for cost effective, high speed production. Mortise widths are standardized. Accordingly, there is no apparent need to adjust corresponding tenon widths. Thus, the '524 patent essentially teaches a complicated structure that offers no real advantage in nested based CNC manufacturing, and it therefore proceeds in a different direction than that which is currently being pursued. What has been said about the '524 patent applies even more strongly in respect to the other patents, mentioned in passing above, that are cited in the '524 patent.

Accordingly, there is a need for a router bit to efficiently form tenons at precise positions on selected edges of work pieces created from sheet stock, in situ. There is a further need to provide such a router bit that will act as a compression bit. Finally, there is a need, in some circumstances, for such a bit that can also provide three-position cutting action, as described above.

### SUMMARY OF THE INVENTION

The present router bit comprises a shaft supporting a pair of cutters longitudinally separated in fixed mutual displacement by an intermediary structure. In some embodiments, the intermediary structure comprises or supports a third cutter. Certain embodiments provide means for separating components of the router bit, e.g., for replacement or maintenance. In many embodiments, the two principal cutters are shaped and oriented such that the router bit is as a compression bit. Certain embodiments provide cutter capability at the lower end of the bit, so that the bit can be used as a “plunge” cutter. However, all embodiments lack any projection beyond the lower cutter, other than those elements of the lower cutter that enable such plunge cutting.

Other aspects of the invention, in its various embodiments, will be seen in reference to the Drawing and the ensuing discussion.

### BRIEF DESCRIPTION OF THE DRAWING

FIG. 1 is a perspective elevation of a router bit according to a first embodiment of the invention.

FIG. 2 is a side elevation view of the router bit shown in FIG. 1.

FIG. 3 is a side elevation view of the router bit shown in FIG. 2, but rotated approximately 90° relative to the orientation shown in FIG. 2.

FIG. 4 is a plan view of the lower end of the router bit shown in FIGS. 1, 2 and 3.

FIG. 5 is a perspective elevation of a router bit according to a second embodiment.

FIG. 6 is a side elevation view of the router bit shown in FIG. 5.

FIG. 7 is a plan view of a work piece region, wherein the router bit of the embodiment shown in FIGS. 5 and 6 is cutting a tenon along an edge of a part being created.

FIG. 8 is a plan view of the work piece region shown in FIG. 7, wherein tenon cutting has progressed to the opposite edge of the part being created.

FIG. 9 is a plan view of the work piece region shown in FIGS. 7 and 8, wherein, subsequently to tenon cutting, part outlining is occurring using a conventional router bit.

FIG. 10 is a side elevation view through Section 10-10 of FIG. 8, showing the router bit of the alternative embodiment shown in FIG. 5 cutting a tenon in a work piece region according to the embodiment of the method of the invention shown in FIGS. 7, 8 and 9.

FIG. 11 is a plan view of a work piece region, wherein an ordinary router is creating a channel along one edge of a part being created, according to the preferred embodiment of the method of the invention.

FIG. 12 is a plan view of a work piece region, wherein channels have been cut at opposite edges of a part being created, and the router bit of the preferred embodiment is cutting a tenon along an edge of the part.

FIG. 13 is a plan view of the work piece region shown in FIG. 12, wherein a tenon has been cut along one edge of the part, and a tenon is being cut along the opposing edge of the part.

FIG. 14 is a plan view of the work piece region shown in FIGS. 12 and 13, wherein tenons have been cut along opposite edges of the part, and the part is being outlined with a conventional ordinary router bit.

FIG. 15 is a side elevation view through Section 15-15 of FIG. 11, showing an ordinary router bit cutting a channel in the work piece, according to the first embodiment of the method of the invention, wherein the tip of the ordinary router bit extends into the spoil board.

FIG. 16 is a side elevation view similar to the view shown in FIG. 15, but wherein the part is onion skinned by retention of a thin layer of the part near its bottom surface.

FIG. 17 is a side elevation view through Section 17-17 of FIG. 12, showing a router bit cutting a tenon in a work piece according to the first embodiment.

FIG. 18 is a perspective plan view of a part having “blind” or “stop” (i.e., not full length) tenons created in opposite edges.

FIG. 19 is a perspective elevation of a router bit according to a third embodiment of the invention.

FIG. 20 is a side elevation view of the router bit shown in FIG. 19, but rotated approximately 90° relative to the orientation shown in FIG. 19.

FIG. 21 is a side elevation view of the router bit shown in FIG. 19.

FIG. 22 is a plan view of the lower end of the router bit shown in FIGS. 19, 20 and 21.

FIG. 23 is a side elevation view of a router according to a fourth embodiment.

FIG. 24 is an exploded perspective plan view of a fifth embodiment, wherein the router bit comprises a number of individual elements that would be assembled for use.

FIG. 25 is an exploded perspective plan view of a sixth embodiment, wherein the router bit comprises a number of individual elements that would be assembled for use.

FIG. 26 is an exploded perspective plan view of a seventh embodiment, wherein the router bit comprises a number of individual elements that would be assembled for use.

### DETAILED DESCRIPTION OF THE PREFERRED EMBODIMENTS

In order to insure clarity in this discussion, certain conventions will be adopted. The terms “upper,” “above,” “intermediary,” “lower” and “below” refer, in respect to elements of the router designs, to the relative longitudinal positions of these elements as shown in side elevation, e.g., in FIG. 2. “Axial” refers to the axis of rotation of a router bit. “Longitudinal” refers to the direction of the router bit axis, and “longitudinally” means “along the axial direction.” “Fixed longitudinal displacement” means that the longitudinal distance separating elements of the particular router is fixed, even though particular elements might be selectively detachable. “Radial” means at a right angle to the longitudinal direction. “Oblique” means at a non-zero angle in respect to the longitudinal direction. The terms “right” and “left” mean that the elements thus referred to project radially in substantially opposite directions, the designation of which is “right” and which is “left” being essentially arbitrary, but believed clear from the Drawing in light of the Specification. “Integral” means that the particular bit embodiment is constructed from a single piece of material. “Detachable” means that elements of the particular bit may be attached and detached selectively.

The various embodiments of the router bit of the present invention will be described in the order shown in the Drawing. Which of these might be considered the “preferred embodiment,” as opposed to an alternative embodiment, is a matter of design choice in respect to the application for which that bit is intended. This will be explained further as the various embodiments are described.

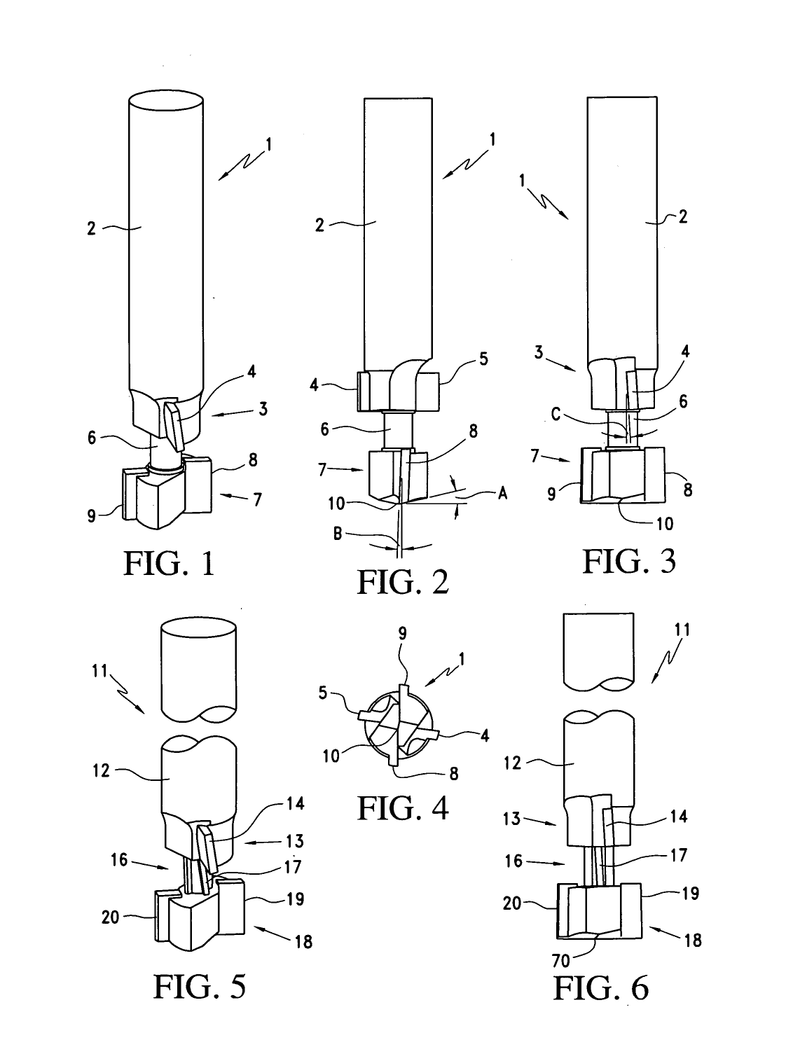

Referring to FIG. 1, the router bit 1 of the first embodiment of the invention comprises a longitudinally-extending principal shaft 2, below which is an upper cutter 3, from which an upper left blade 4 radially projects, as shown. The upper right blade 5 (see, e.g., FIG. 2) projects radially from the principal shaft in the opposite direction from that of the upper right blade. Longitudinally displaced below the upper cutter at a rigidly fixed distance is a lower cutter 7, comprising a lower right blade 8 and a lower left blade 9 (see, e.g., FIG. 3), projecting radially in opposite directions. The upper cutter and the lower cutter are separated by an intermediary shaft 6, whose diameter is less than that of the principal shaft for reasons that will be explained. The lower cutter is positioned in proximity to, and below, the lower end of the intermediary shaft.

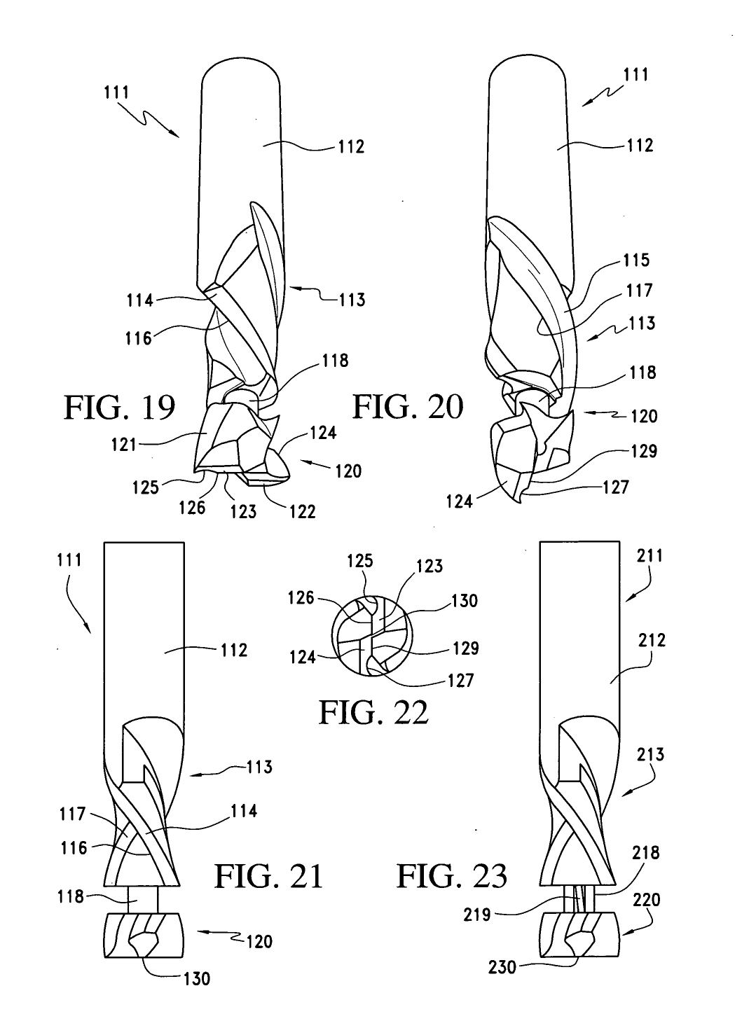

It will readily be seen that in the embodiments shown in FIGS. 1 to 18, the various blades are “wing blades,” i.e., they are essentially rectangular and project radially. This is in contrast to the spiral blades shown, e.g., in FIGS. 19 to 23 and described, below, in connection therewith.

At this juncture, it should also be noted, as stated, that the upper cutter 3 and lower cutter 7 are separated by a rigidly fixed distance. This is in contrast to the configuration taught in the '524 patent, which purports to make this separation adjustable. The reason for this distinction is that the router bit taught in the '524 patent is designed exclusively for cutting on the edge of a work piece that has already been removed from the sheet stock. On the other hand, the router bit of the present invention is designed principally for nested based CNC applications, where tenon cutting occurs on the work piece in situ, before the work piece is separated from the sheet stock. Thus, in the router bit of the present invention, the longitudinal distance between the upper cutter and lower cutter is fixed when the router bit is manufactured or assembled, so that, in use, it will create tenons of a specific desired width. The longitudinal spacing of the two cutters can easily be determined and implemented by a tool manufacturer, in light of these teachings, so that the desired tenon width can be achieved despite slight wastage from the cutting process.

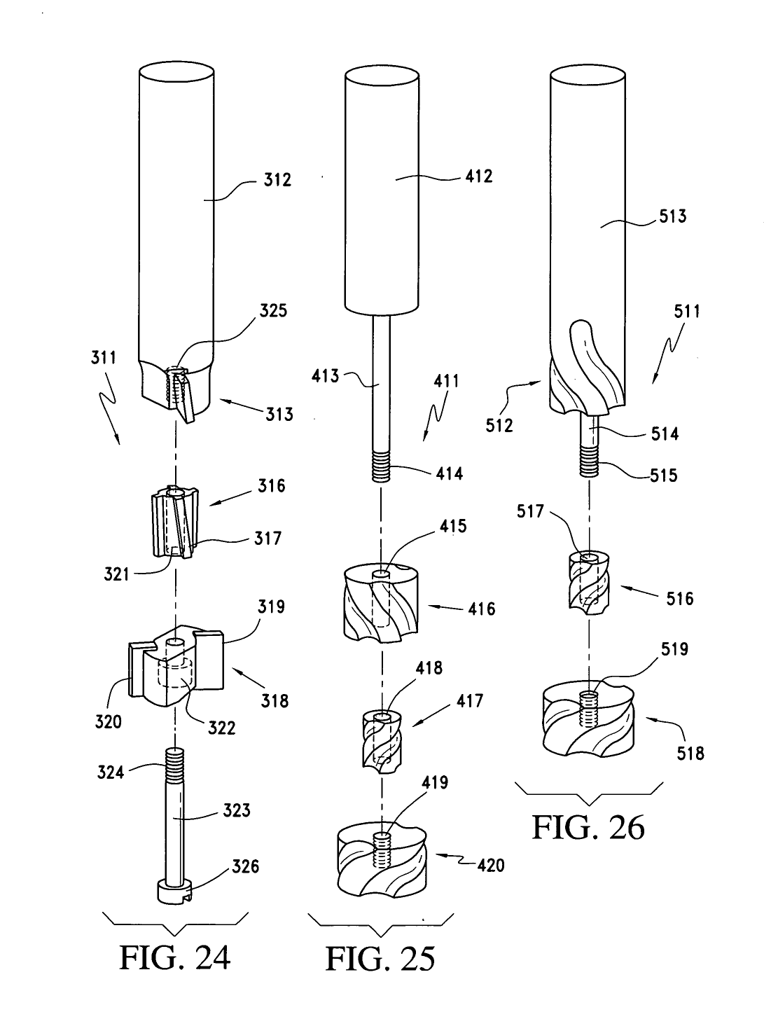

Typically, all of the elements of the router bit 1 thus far identified will be fabricated as an “integral device,” i.e., collectively constituting a single piece of material. However, except that the longitudinal spacing between the upper cutter 3 and the lower cutter 7 is fixed, the invention does not depend on all router elements being integral. It can be envisioned that some of the elements, such as wing blades, might be selectively detachable, e.g., for replacement necessitated by breakage or wear. Also, as explained in connection with FIGS. 24 to 26, the bit may be assembled from separate parts. Nevertheless, it is believed that an integral router bit, fabricated from a single piece of hard steel or other suitable composition, is preferred to a router bit in which various elements are detachable, as this would tend to permit higher rotational and forward cutting speeds without excessive wear and breakage, thus facilitating a high production rate and cost-effectiveness. But this choice is left to the practitioner of ordinary skill, in light of these teachings, as is selection of the material from which the router bit is formed, as router bit fabrication, generally, is well known.

FIG. 2 shows the router bit 1 rotated clockwise (i.e., from right to left) approximately 90° from its position in FIG. 1. In the configuration shown in FIG. 2, the upper right blade 5 can be seen projecting from substantially the opposite direction from the upper left blade 4. Also shown in FIG. 2 is the lower point 10 of the lower cutter 7 of the router bit, which tapers upward at an angle A (which may be zero) along two sides, as shown. Whatever the angle (even if zero), the router bit may efficiently be used as a plunge cutter, in selective applications that will be described below. The value of this angle A, if non-zero, for particular applications with specific types of work pieces, can be determined by the practitioner of ordinary skill, in light of these teachings, as its plunge cutting function is believed clear in this context. But it should be noted that the lower point of the lower cutter is the ultimate projection of the router bit. This contrasts sharply with the '524 bit.

It will readily be noted, from FIGS. 1 and 2 and from related figures of the Drawing, that the various blades 4, 5, 8, 9 comprising elements of the respective cutters 3, 7 of the router bit 1 are projections from corresponding bases of more substantial construction. The latter elements are not specifically identified or described, as they are typical of router bits, and will be quite familiar to those of ordinary skill in the art, in light of these teachings, as will their manner of construction.

FIG. 2 also shows that the orientation of the lower right blade 8 is oblique in respect to the axis of the router bit 1, and tilts, in respect thereto, at an angle B. FIG. 3 correspondingly shows that the upper right blade 4 is likewise oblique in respect to the router bit axis, tilting, in respect thereto, at an angle C, but in the opposite orientation to the tilt of the lower right blade. Upper left blade 5 generally tilts by the same amount and in the same orientation as upper right blade 4, and lower left blade 9 generally tilts by the same amount and in the same orientation as lower right blade 8. It is assumed, with these orientations, that the router bit 1, in use, will be rotated in a clockwise direction, looking downward from the upper end to the lower end of the bit, i.e., right to left, in side elevation, from the orientation shown in FIG. 1 to that shown in FIG. 2. In this case, the router bit will be a compression bit, causing the bottom and top surfaces of the work piece to compress toward one another in use. This is a desirable feature, as it will tend to preserve the integrity of the work piece surfaces. Of course, if the bit is to be rotated counter-clockwise, the relative orientations of the blade tilts would be opposite to that shown and described. These aspects of the design will be well understood by those of ordinary skill in light of these teachings.

The choice of angle B and angle C values may be significant, as the blades 4, 5, 8 and 9 must provide efficient cutting, while not promoting excess stress that would result in premature wear or breakage. I have found that values of approximately 10° or somewhat more for angles B and C appear to provide an effective compromise with most materials. However, as will be discussed below, much depends on the actual work piece and bit materials. Thus, practitioners of ordinary skill are invited to experiment with other angles. All angles would be within the scope of the invention as claimed, their selection being merely a design choice in light of these teachings.

FIG. 4 shows the first embodiment of the router bit 1, viewed upwardly from the lower point 10 of the router bit. All elements here shown are as shown in respect to FIGS. 1 to 3.

FIGS. 5 and 6 show a router bit 11 of a second embodiment of the invention. Here, the intermediary shaft 16 is actually a third-position cutter, with obliquely oriented blades 17 projecting radially. In all other respects, this second router bit is similar to the router bit 1 of the first embodiment, shown in FIGS. 1 to 4. E.g., this second router bit comprises an upper shaft 12; an upper cutter 13, with an upper left blade 14 and upper right blade (15, not shown, but projecting radially opposite the upper left blade); an intermediary shaft 16 with radially-projecting blades 17; and a lower cutter 18, with a lower right blade 19 and lower left blade 20. The lower cutter ends in a tip 70.

As in the case of the router bit 1 of the first embodiment, the various blades are set obliquely. The blade orientations in the upper cutter 13 and of the lower cutter 18 are set so that this bit 11, like the first router bit 1, will act as a compression bit. The respective angles are preferably the same as in the case of the first router bit 1. The blades 17 of the intermediary shaft 16 are set obliquely in a conventional manner, and the angles of these blades, in respect to the longitudinal axis, can be set by the practitioner of ordinary skill in light of the present teachings, but would usually be in the same range as in the case of the above described angles B and C.

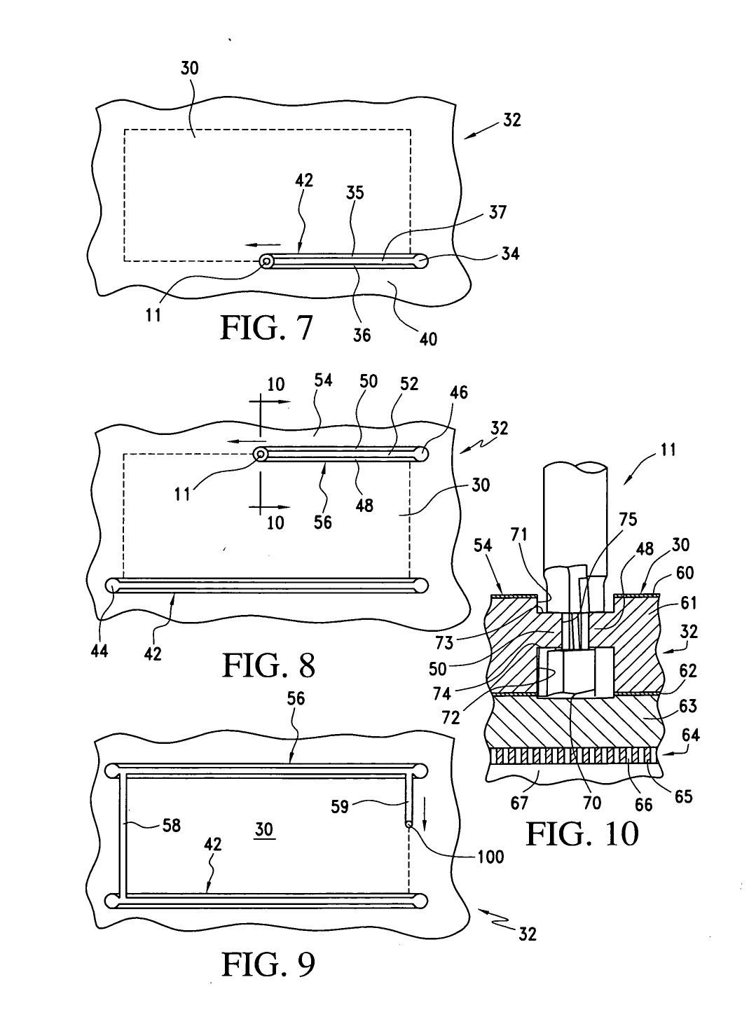

Use of this second, alternative router bit 11 may be described in the context of FIGS. 7 to 10 of the Drawing, where it is assumed that the work piece 32 is held by a strong vacuum on a work table (see, e.g., FIG. 10), as is the case in all methods described herein. It will be recalled that the chief advantage of the various router bit designs of this invention is that they enable tenons to be cut, in situ, in a CNC nested based operation, unlike the prior art bits, such as the '524 bit.

Referring first to FIG. 7, we see a principal work piece 30, e.g., a cabinet bottom, being shaped for removal from sheet stock 32 in a CNC nested based operation. In this embodiment of the router bit and method, an initial hole 34 is first cut into the sheet stock by the second router bit 11, which, as pointed out, above, and seen from the Drawing, is a plunging bit. The bit traces the path shown by the arrow, along one edge of the work piece being formed, to create initial separation 42. Here, a first principal tenon 35 is cut into the principal work piece, while a first adjacent tenon 36 is simultaneously cut into the first adjacent work piece 40, leaving a first channel 37 between those two adjacent parts.

FIG. 8 shows the next step in this second embodiment. Here, the entire initial separation 42 has been cut between the principal work piece 30 and first adjacent work piece 40, with tenons cut into the facing edges of each of these parts, as described. The second router bit 11 is then removed from the work piece at terminal hole 44 and moved to a position diagonally opposite that position, to cut the second initial hole 46, initiating creation of the secondary separation 56. As with all of these nested based process steps, this procedure is likewise automated by conventional CNC programming. After having cut the second initial hole, the router bit is moved along the direction of the arrow shown in FIG. 8 to create the secondary separation 56. In this process, the second principal tenon 48 is cut into the principal part on the opposite edge of that part from the first principal tenon 35. I.e., in this example the final part will have tenons on opposite edges. Of course, in other applications, tenons can be cut along any edge of any part, and in an alternative sequence and direction, as would be well understood by those of ordinary skill in light of these teachings. Where the tenons are cut depends on the desired configurations of the various parts, and this, in turn, is provided by selective programming of the CNC device. In any event, in this example, the bit creates a second adjacent tenon 50 in the second adjacent part 54, leaving a second channel 52 remaining between those two adjacent parts.

Referring to FIG. 9, we see that after the opposite edges of the principal work piece 30 have been operated upon, resulting in the initial separation 42 and secondary separation 56, with tenons as described, the alternative router bit 11 is removed by the CNC machine, and the work piece is outlined from the sheet stock 32 for removal. This is accomplished by an ordinary router bit 100, in a conventional manner, familiar to those who understand CNC nested based operations. Briefly, the work piece is outlined by creation of a first removal channel 58 and, on the opposite side of the principal part, a second removal channel 59.

Mating mortises would be created in a selective work piece or work pieces, conventionally in situ, by CNC procedures, using an ordinary router, as is well known and understood.

FIG. 10, which is a section through 10-10 of FIG. 8, shows the second router bit 11 cutting the secondary separation 56, just described. Shown here are the various layers of the sheet stock 32, and of the principal work piece 30 and second adjacent work piece 54. These are the top melamine layer 60, core 61 and bottom melamine layer 62. Of course, the top and bottom layer might consist of some material other than melamine, discussed above.

Beneath the sheet stock 32 is the spoil board 63, into which the tip 70 of the second router bit 11 extends slightly during the cutting operations. The various sectional FIGS. 10, 15 and 17 show this slight penetration into the spoil board as being deeper than typically it actually is, for the purposes of clarity. It will be understood that after all of these operations have been completed, the spoil board will display a pattern of shallow channels in its upper surface. Eventually, the spoil board will need to be replaced when its surface has been fully compromised. Those of ordinary skill understand the criteria for replacement of spoil boards.

The interface 64 of the vacuum work table displays an alternating pattern of structural webbing 65 and vacuum conduits 66. This interface separates the spoil board 63 from the vacuum chamber 67. Further details of the vacuum work table are believed unnecessary to describe, as they are well known to ordinary practitioners and do not relate directly to the invention.

The second router bit 11 and related method, as described, may not presently be the preferred embodiment of the invention, although, as will be explained, that embodiment, or a variation, is likely to become superior to the first router bit 1 and its related method as technology advances. But these considerations should be addressed in the use of such a second router bit.

First, while the obliquely oriented blades 17 of the intermediary shaft 16 allow the second bit 11 to trim the outer projections of the tenons formed by use of the router of this invention, such trimming may not be necessary. This is because tenons and mortises are normally joined by applying an adhesive to some or all of the base 71 and 72 of a tenon, its sides 73 and 74 and the corresponding surfaces of the corresponding mortise, but not necessarily to the tip 75, of the tenon 35. Thus, the projected length of the tenon is somewhat less important, so long as it is not greater than the depth of the corresponding mortise. Accordingly, as it is not normally required to trim the projection length of the tenons, these intermediary shaft blades will typically be unnecessary for that particular purpose. However, the presence of obliquely oriented blades on the intermediary shaft can eliminate processing steps in some applications, such as shown in FIGS. 7-9, where such a bit can plunge cut, bottom cut and edge cut, as shown. This is certainly an advantage.

However, the process just described, utilizing an alternative, second router bit 11, may still not be the presently preferred one for structural reasons. As is well known, the stresses encountered by router bits are enormous, resulting in rapid wear and occasional breakage, at least with currently-available metal formulations. Thus, it may not presently be desirable to use that second router design to simultaneously cut two facing tenons, as this might place an unacceptable strain on the bit, necessitating reduction in rotational speed or linear cutting speed or both. Thus, while the second router bit and method just described laudably saves processing steps over use of the first-described router bit 1, this might be a false economy with current technology in some applications, in view of reduced cutting speeds or increased wear or breakage. However, as technology continues to advance, it can easily be envisioned that, perhaps in the near future, metal, ceramic, carbide or other materials of extreme toughness may become available; in which case the router bit 11 and method just described would probably be preferred to the router bit 1 design.

But there remains another issue. It can be seen that the wing blades 17 in the intermediary shaft 16 are necessarily spaced fairly closely within a somewhat confined area. To create these intermediary blades in an integral second router bit 11 embodiment of the present invention, it is necessary, with present technology using a metallic composition, to insert a grinder into that area to create and sharpen these blades. Thus, while such an integral bit might be structurally superior to one in which the wing blades are selectively removable, insertion of such a grinder into that confined space may be difficult, with present technology. However, it can easily be anticipated that with advances in ceramic, carbide and other hard, tough materials, the entire router bit might be cast integrally, or at least the intermediate shaft area might more easily be provided with oblique blades

Alternatively, as shown in FIGS. 24 to 26, the second router bit 11 (and variations shown there and referenced in the accompanying text) could be fabricated as selectively attachable elements, one of which would be a collar with blades that could be made independently and then inserted in place. See, below, for a fuller description of these alternative embodiments.

Thus, the embodiment shown in FIGS. 1 to 3 and 11 to 14 appears presently preferable to that shown in FIGS. 5 to 10 in the case of an integral router bit, although, as technology continues to advance, an integral alternative bit 11 will probably become preferable simply because its use can eliminate processing steps. The bladeless intermediary shaft of the router bit 1 of the first embodiment, in most applications, will not abut any portion of the part being formed, its purpose being merely to separate the two cutters 3 and 7 of the router bit by a fixed longitudinal distance, so that tenons of prescribed width can easily be cut in situ in a nested based CNC operation.

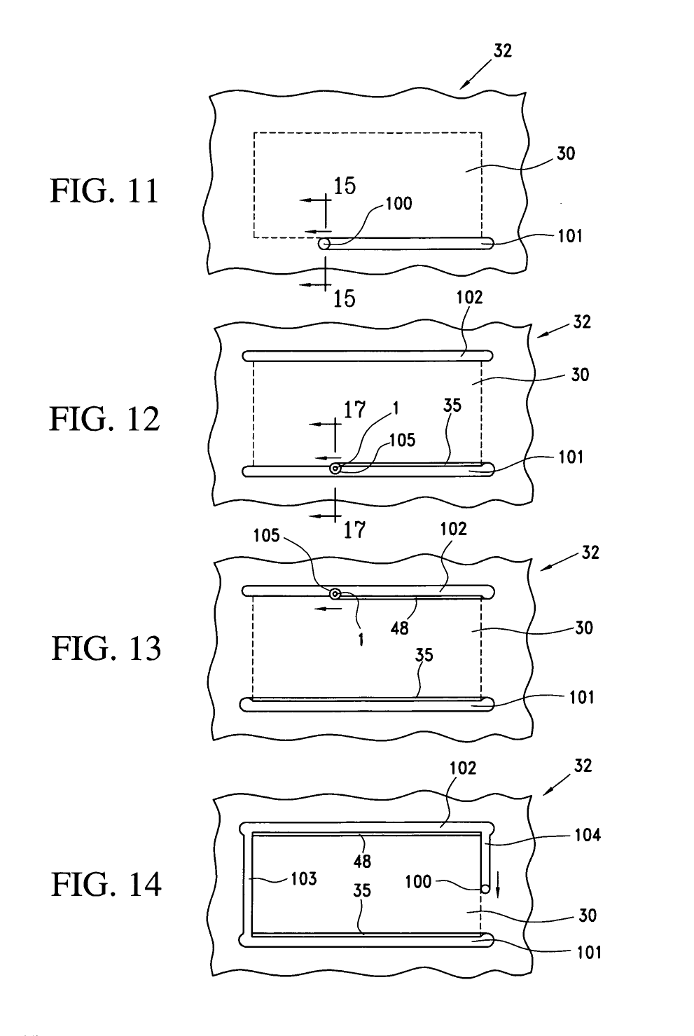

Referring, then, to FIG. 11, an ordinary router bit 100 cuts a first outline 101 in the sheet stock 32, identifying a first edge of what will eventually become a work piece 30.

In FIG. 12, the first described embodiment of the router bit 1 cuts the first principal tenon 35 along the edge of the work piece 30 that has been exposed by the first outline 101. It will be noted that the first outline is shown, correctly, as being slightly greater in width than the diameter of the router bit 1, which, in turn, is offset very slightly toward the edge of the work piece, leaving a space 105. This prevents the router bit, in this embodiment, from cutting a tenon in the facing edge of the work piece, as is done in respect to the first adjacent tenon 36 in the alternative embodiment discussed above in respect to FIG. 7, et seq. Once again, this is to enable this router bit to be used at maximum rotational and linear cutting speed, to expedite part formation without hastening wear or destruction of the bit, which will eventually wear and have to be replaced in any event.

FIG. 13 shows a further stage of formation of the work piece 30, where the first router bit 1 follows the second outline 102 to create the second principal tenon 48 at the opposite edge of the part. In doing so, the router bit of the present invention follows the second outline 102, which has previously been created by the ordinary router 100. Once again, the router bit of the invention is offset slightly toward the part, as in creation of the first principal tenon 35, and for identical reasons.

Of course, the direction in which the first router bit 1 follows in the first outline 101 can be the same as or opposite to the direction it follows in the second outline 102, as the practitioner desires. This is true of all embodiments of the router bit of the present invention, in respect to the outlines followed in cutting the respective tenons in situ.

Final outlining of the part 30 is completed as shown in FIG. 14. Here, the ordinary router 100 completes outlining of the part by cutting the third outline 103 and fourth outline 104, which connect with the first outline 101 and second outline 102. In most cases, the work piece is now ready to be removed from the sheet stock 32 whenever desired.

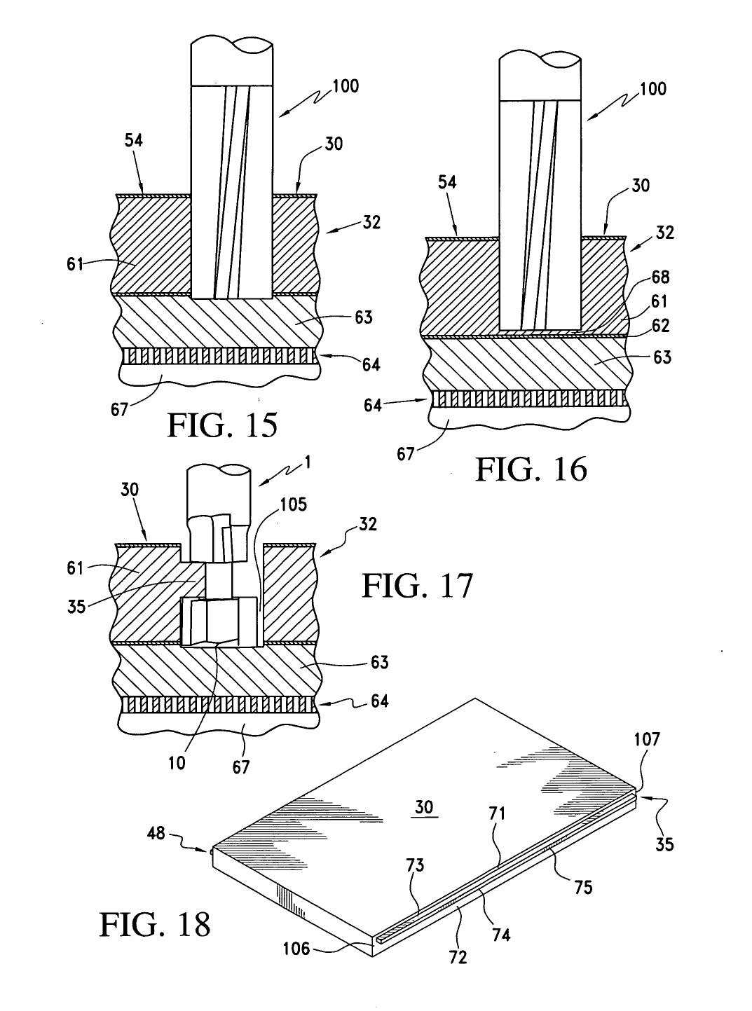

The configuration of the normal outlining process is seen in FIG. 15. Here, the ordinary router bit 100 cuts through the sheet stock 32, slightly into the upper portion of the spoil board 63. This is the procedure used where the work piece 30 is large enough to be held firmly by the vacuum table during the various processing steps, such as described above. The configuration shown sectionally in FIG. 15 occurs at each step in which an ordinary router is used for such larger parts.

However, where the work piece is too small to be held securely by the vacuum table, an additional step is required before final outlining and work piece separation. This is the “onion skinning” step indicated sectionally in FIG. 16. Here, the ordinary router bit 100 does not quite reach the bottom (non-porous) layer 62, leaving it intact below a thin section 68 of the core 61, until all of the tenon cutting steps mentioned above, in the various embodiments of the process, are completed. Final outlining, i.e., cutting through the bottom layer, is accomplished when the work piece is ready to be removed. This is normally the final step in the work piece formation process.

FIG. 17 shows, sectionally, the configuration of tenon cutting using the first described embodiment of the router bit 1 in the present embodiment of the method. Here, the router bit cuts the tenon 35 along one edge of the part 30. Because the tip 10 of the router bit projects slightly into the spoil board 63, there is no onion skinning here, implying that this is a relative larger work piece.

FIG. 18 illustrates a finished work piece 30, with tenons 35 and 48 cut into opposite edges. It will be noted that this work piece contains a blind or stop tenon, provided with spaces 106 and 107, flush with the base 71 of the tenon, at either end. These can be created by a separate operation with an ordinary router, or in any other convenient manner. The part shown in this FIG. 18 could have been created by use of the first described router bit 1, following the procedures described in respect to FIGS. 11 to 14, or by use of the second described router bit 11, following the procedures described in respect to FIGS. 7 to 10. It will be noted that the tenons are offset from the center of the edge, toward the upper (interior) work piece surfaces, as would result from the configuration shown in FIG. 17. This is a normal configuration, but may, of course, be varied, as desired, by the practitioner.

Before proceeding to a description of the third and fourth embodiments of the router bit, shown, respectively in FIGS. 19 to 21, and FIG. 23, problems often encountered with lower grades of sheet stock material will be mentioned. As is well known by those of ordinary skill in the art, and as will be understood intuitively by most laymen, it is not always possible to obtain sheet stock of uniformly high quality material. Some materials are well made, with wood particles of proper size, securely bonded for excellent strength and integrity. However, some are not so well made. The problem is that poorer material grades cannot readily be operated upon with certain router bit configurations in high speed protocols without fracturing or splintering of the material. Since it is always desirable to fabricate high quality parts in rapid succession, and since high quality sheet stock is not always uniformly obtainable, due care must be taken either in the choice of router bit configurations or in programming of CNC nested base operations, or both. Since it is generally more economical to employ modified bit designs than to obtain special CNC software designed specifically for lower quality materials, I have carefully developed bit configurations that appear to work substantially equally well with high and lower quality work piece materials.

Initially, it should be pointed out that what has been shown and said regarding the first and second router bit designs, 1 and 11, respectively, and regarding the methods described above in using them to form tenons and parts applies, without reservation, where reasonably high quality work piece materials are utilized. Furthermore, these bits and processes can be successfully used in virtually all cases if the operator is willing to adjust cutting speeds to compensate for lower quality material, to obviate otherwise inevitable fracturing and splintering. But if high speed production is desired with sheet stock materials whose quality may vary randomly and considerably, it is believed that the router bit configurations now to be described may provide more uniform results.

These further designs are within the inventive concept, because each displays the salient features of the invention: two axially aligned cutters with fixed longitudinal displacement, typically integral with a shaft, with no substantial projection beyond the lower cutter. It is merely the shape of the principal cutters, in these embodiments, which differs from those earlier described. Specifically, the embodiments shown in FIGS. 19 to 23 employ spiral upper and lower cutters instead of wing bladed cutters, as shown in FIGS. 1 to 6, 10 and 17. But the choice between the various router bit configurations herein described, and others equally within the inventive concept, is ultimately well within the expertise of those of ordinary skill, in light of these teachings. In fact, it is possible that one of many possible designs within the scope of the invention might provide superior results for some operators in some cases, while others might provide superior results in other cases, or for other operators. Thus, only some of the many possibilities will be described herein, the rest being relegated to modification and case-by-case selection by others of ordinary skill, within the scope of the invention, in accordance with the present teachings.

Referring, now, to FIGS. 19 and 20, we see that the third embodiment of the router bit comprises an upper shaft 112 with an upper spiral cutter 113 incorporated into the lower end of the upper shaft. The upper spiral cutter incorporates a first upper spiral 114 and, on the opposite side of the upper spiral cutter, a second upper spiral 115 (see, e.g., FIG. 20). The first upper spiral cutter includes a first upper spiral cutting edge 116, and the second upper spiral 115 includes a second upper spiral cutting edge 117. It will be noted that when this router bit is rotated clockwise, i.e., from the configuration shown in FIG. 19 to the configuration shown in FIG. 20, the bit will tend to force the upper surface of the work piece downward. Accordingly, the upper spiral cutter may be referred to as a down cut spiral.

Of course, each of the two spirals 114 and 115 includes appropriate support material to provide structural integrity for high speed operation. This is conventional and will not be described in any further detail, as such structures are well known.

Between the upper spiral cutter 113 and lower spiral cutter 120 is an intermediary shaft 118 whose primary purpose is to separate the two cutters by a fixed longitudinal displacement, as previously explained in respect, e.g., to FIGS. 1 and 2. Once again, it is a feature of the present invention that two separate cutters are in fixed longitudinally displaced from one another. In this embodiment, it is the intermediary shaft which insures that this displacement is fixed.

As shown in FIGS. 19 and 20, but perhaps more clearly in FIG. 22, the lower spiral cutter 120 likewise displays two spirals. The first lower spiral 121 includes a first lower spiral cutting edge 123, containing a first piercing notch 125 in its first lower spiral cutting blade 126. Likewise, the second lower spiral 124, on the opposite side of the lower spiral cutter from the first lower spiral, includes a second lower spiral cutting edge 122, containing a second piercing notch 127 in its second lower spiral cutting blade 129.

As shown specifically in FIGS. 21 and 22, the first lower spiral blade 123 and second lower spiral 124 converge at the apex 130 of the lower spiral cutter 120. While the face of the lower spiral cutter is shown as being flat, in side elevation view, in FIG. 21, it can be somewhat pointed, if desired for the particular application. In other words, the first lower spiral cutting blade 126 and the second lower spiral cutting blade 129 can be fabricated to tip downward toward the apex, giving a slightly pointed aspect to the lower end of the router bit 111. All embodiments of the present invention can display a flat or pointed lower cutter face, as chosen by the practitioner.

However, in any case it should be carefully noted that in the embodiment shown in FIGS. 19 to 22, as in the previously described embodiments, shown in FIGS. 1 to 6, 7 and 10, there is no substantial longitudinal projection from the bottom cutting edges of the router bits of the present invention. That is to say, when any of these bits are used as plunging bits, they can position their respective cutters to correctly cut tenons of the proper width and proper position in respect to the part surfaces without extending more than slightly into the spoil board. Thus, in all embodiments of the invention, the spoil board's utility life is extended far more than it would be if the router bit of the '524 patent were employed, and, consequently, deeper channels would have to be cut as a separate step in the spoil board, to enable the '524 patent cutters to be properly placed in respect to the edge and surfaces of the part being fabricated. This is to say, once again, that the '524 patent bit is not adaptable to CNC nested base tenon cutting.

It will be noted, from FIGS. 19 to 21, that whereas the upper spiral cutter 113 is “down cutting,” the lower spiral cutter 120 is “up cutting.” This is due to the respective orientation of the respective blade directions. Thus, this embodiment, as the previously described ones, is a compression bit. Also, due to the placement and shape of the cutting edges, this embodiment of the router bit of the invention, like the previously described embodiments, can be used to plunge cut.

Once again, in passing, it should be noted that the exact configuration of this router bit 111 may be altered by those of ordinary skill in the art to achieve a desired advantage in specific applications, of which there are doubtless many. So long as the basic features of the invention are preserved, the specific angles, lengths, widths, thicknesses, etc., of the components of the resulting router bit will not serve to draw any such design out of the range of the invention. Accordingly, those of ordinary skill may experiment freely, in light of these teachings, without eluding the scope of the invention.

Referring to FIG. 23, we see that the router bit 211 is identical to the previously described router bit 111, except that the intermediary shaft 218 bears a wing blade 219 on either side. Thus, while this fourth embodiment of the router bit of the present invention bears upper and lower spiral cutters as in the case of the previously described bit, the intermediary portion can also cut. Accordingly, what has been said about the second embodiment router bit 11 applies essentially equally to this one. Of course, instead of wing blades, spiral blades or blades of any other shape could project from the intermediary shaft, according to the desires of the practitioner, still within the scope of the invention. In any event, the upper shaft 212 corresponds to the upper shaft 112 of the FIG. 19 embodiment, the upper spiral cutter 213 corresponds to the upper spiral cutter 113 of the FIG. 19 embodiment, the lower spiral cutter 220 corresponds to the lower spiral cutter 120 of the FIG. 19 embodiment and the apex 230 likewise corresponds to the earlier described apex 130.

Attention will now be directed to FIGS. 24, 25 and 26, which are, respectively, the fifth, sixth and seventh embodiments of the router bit described herein. Of course, as has been suggested on a number of occasions, these, too, are merely alternative embodiments of the same concept.

As a brief introduction, it can readily be seen that the fifth router bit 311 is essentially a detachable version of the second router bit 11. Likewise, the sixth router bit 411 and seventh router bit 511 are each detachable variations of the fourth router bit 211, where the intermediary cutter in the sixth and seventh router bits is a spiral cutter, rather than a wing blade cutter, as in the fourth bit. Of course, a perfectly viable variation of the fourth router bit could substitute a spiral intermediary cutter for the wing blade cutter shown in FIG. 23. Also, detachable versions of the first router bit 1 can be visualized by reference to FIGS. 1 and 24. The practitioner of ordinary skill may easily envision still further variations within the scope of this invention, as described and claimed.

Since most of the elements present in FIGS. 24 to 26 have already been fully described above, reference to these final three figures will be made in somewhat summary fashion.

In FIG. 24, we see that the fifth router bit 311 comprises a fifth upper shaft 312 terminating in a fifth upper cutter 313, here configured as a wing blade cutter, as are all cutters in this particular embodiment. Below the upper cutter is a detachable intermediary cutting collar 316, bearing a wing blade 317, as shown, with a second such wing blade on the opposite side, not shown. The intermediary cutting collar is pierced axially by an intermediary positioning duct 321. The detachable lower cutter 318, bearing a first wing blade 318 and a second wing blade 319, is pierced by a bolt head nest 322. When this fifth router bit is assembled, the retention bolt 323 passes through the bolt head nest, through the intermediary positioning duct, until its upper threading 324 securely engages the threaded retention recess 325 in the upper cutter and the bolt head 326 securely rests in the bolt head nest in the lower cutter. Of course, the upper threading may be positioned further upward, partially within the upper shaft. This is merely one of many variations possible in this embodiment that would occur to the practitioner of ordinary skill.

Before moving onward to the sixth router bit 411, shown in FIG. 25, it should be pointed out that any or all of the wing blade cutters in FIG. 24 could easily be replaced by a spiral cutter. No separate figure showing this is believed necessary, as such a substitution would be readily apparent to those of ordinary skill. It should perhaps also be noted that orientation of the threading on the retention bolt 323 should be chosen to cause the entire assembled fifth router bit to tighten as it revolves, as is done in many other ordinary applications, e.g., saw blades attached by screws. This is likewise true of the sixth and seventh router bit embodiments and all other detachable ones.

In the sixth router bit 411, the shaft 412 terminates in an axial retention bolt 413, which bears terminal threading 414. The retention bolt passes through the upper axial positioning duct 415 of the upper cutter 416, here configured as a down-cutting spiral cutter. Below the upper cutter is the likewise detachable intermediary cutter 417, containing an intermediary cutter positioning duct 418, through which the retention bolt also passes, until it engages the lower cutter threading 419 in the detachable lower cutter 420. As in the case of the other embodiments shown and described, this sixth embodiment router bit is a compression bit, with down cutting upper cutter and up cutting lower cutter. The intermediary cutter, in FIG. 25 is up cutting, but may be configured as a down cutter, although up cutting, here, is preferred to preserve the integrity of the cut tenons.

Finally, in FIG. 26, we see the seventh router bit 511, which is similar to the sixth router bit 411, except that the upper cutter 512 is integral with the shaft 513. It will be noted that, in this embodiment, the retention bolt 514, with terminal threading 515 is shorter than the retention bolt 413 of the sixth router bit, simply because it traverses a shorter distance than the retention bolt of the sixth router bit, since in the present embodiment, the upper cutter is integral with the shaft from which the retention bolt projects. Of course, neither of these two retention bolts 413 and 514 need necessarily be integral with their respective shafts, and could be provided with upper threads to engage mating threading in their respective shafts. However, no advantage is readily apparent in the latter configuration, and it is believed that integral retention bolts 413 or 514 might provide a structure of superior integrity.

Referring again to FIG. 26, the retention bolt 514 projects through the axial positioning duct 517 of the intermediary cutter 516, engaging the internal threading 519 of the lower cutter 518. As can readily be seen, this seventh router bit 511 is a compression bit.

As stated in respect to the second router bit 11, creation of an intermediary wing bladed intermediary cutter might be difficult with today's technology and available router bit materials. Of course, as has been stated, this situation may change with steadily improving technology. However, in the meantime, the detachable embodiments, shown in FIGS. 24 to 26, can provide a more straightforward environment for producing a bladed intermediary shaft, as, with these embodiments, blades could readily be machined into the metal piece from which the intermediary cutter results. When assembled in place, this intermediary cutter can perform all of the functions of the intermediary cutter 16 of the second router bit embodiment. Thus, it is believed that, in view of the present state of relevant technology, the seventh router bit 511 may be the preferred embodiment of the invention, although, as stated, this could change with changing technology.

It is believed that any of the described router bits 1, 11, 111, 211, 311, 411 and 511 will improve tenon cutting in nested base CNC applications over any designs known in the art. The choice among these, or any other designs within the scope of the invention, is entirely left to the practitioner of ordinary skill in light of these teachings.

Mortises and additional machining can be applied to work pieces, in situ, using ordinary routers, all of which, as in the case of the tenon-cutting routers described, being under the control of the CNC machine, which can be programmed as desired, in a manner well known in the art. Of course, decorations can also be applied via separately fabricated or obtained parts attached to the outer surface(s) of selected parts fabricated in accordance with the present teachings.

Whichever configuration is employed—onion skinning or the lack of it; the first described router bit 1 with no cutting blades in the intermediary shaft 6; the second described router bit 11 with cutting blades 17 on the intermediary shaft 16; the third described router bit 111 with spiral-bladed cutters 113 and 120; the fourth described router bit 211 with spiral-bladed cutters 213 and 220 and cutting blades 219 on the intermediary shaft 218; the fifth, sixth or seventh router bits 311, 411 or 511, which are detachable; or any other(s)—the features that distinguish the present router bit configuration from those in the prior art are: (1) the presence of two cutters, e.g., 3 and 7, 13 and 18, 113 and 120, 213 and 220, 313 and 318, 416 and 420 and 512 and 518, in fixed longitudinal mutual displacement, e.g., separated by an intermediary shaft, e.g., 6, 16, 118, 218, 316, 416 or 516 respectively; and (2) the fact that in the router bit of the present invention, there is no substantial projection beyond the tip of the lower cutter, so that it can extend, or plunge, slightly into a spoil board without the need for separately-fabricated channels in the spoil board.

Many modifications, beyond the ones suggested above, would be within the capability of the ordinary practitioner, based on these teachings. For example, the choice of the preferred embodiment is left to the practitioner, to suit the particular circumstances, as is the choice of relative dimensions, e.g., the outside diameter of the router bit of this invention versus the ordinary router bit used for various operations and the diameter of the intermediary shaft. The practitioner is likewise invited to experiment with different metal, ceramic, carbide or other formulations for the router bits and is free to develop, or have developed, any desired computer programming to control use of the routers of the present invention in any desired CNC operation. Those designs suggested merely illustrate the fact that many further alternations and modifications may be made by those having ordinary skill in the art without departing from the spirit and scope of the invention, in light of these teachings. Therefore, it must be understood that the illustrated and described embodiments have been set forth only for the purpose of example and that these should not be taken as limiting the invention as defined by the claims to follow.

The words used in this Specification to describe the invention and its various embodiments are to be understood not only in the sense of their commonly defined meanings, but also to include, by special definition in this Specification, structures, materials or acts beyond the scope of the commonly defined meanings. Thus if an element can be understood in the context of this Specification as including more than one meaning, then its use in a claim must be understood as being generic to all possible meanings supported by the Specification and by the word itself.

Although the actual invention is defined by the following claims, the definitions of the words or elements of the claims include not only the combination of elements that are literally set forth, but also all equivalent structures, materials or acts for performing substantially the same function in substantially the same way to obtain substantially the same result.

I claim:

1. A router bit comprising:
a. a principal shaft having an upper portion, a lower portion, a principal axis and a longitudinal direction along said principal axis extending in a first direction from said upper portion toward said lower portion;
b. a first cutter projecting outwardly from said principal axis proximate to said lower portion;
c. a second cutter projecting outwardly from said principal axis and longitudinally displaced from said first cutter in said first direction;
d. a separator having a separator axis aligned with said principal axis, said separator intervening between said first cutter and said second cutter, longitudinally separating said first cutter from said second cutter by a fixed displacement; and
e. a third cutter comprising at least a longitudinal portion of said separator; wherein
f. no substantial portion of said router bit extends beyond said second cutter in said first direction.

2. The router bit as recited in claim 1, wherein said router bit is an integral unit.

3. The router bit as recited in claim 1, wherein the diameter of said separator is less than the diameter of said principal shaft.

4. (canceled)

5. The router bit as recited in claim 1, wherein said first cutter comprises wing blades.

6. The router bit as recited in claim 1, wherein said second cutter comprises wing blades.

7. The router bit as recited in claim 1, wherein said third cutter comprises wing blades.

8. The router bit as recited in claim 1, wherein said first cutter comprises a spiral blade.

9. The router bit as recited in claim 1, wherein said second cutter comprises a spiral blade.

10. The router bit as recited in claim 1, wherein said third cutter comprises a spiral blade.

11. The router bit as recited in claim 1, wherein said router bit comprises a plunging bit.

12. The router bit as recited in claim 1, wherein the face of said second cutter is flat

13. The router bit as recited in claim 1, wherein the face of said second cutter is pointed.

14. The router bit as recited in claim 1, wherein said router bit is a compression bit.

15. The router bit as recited in claim 1, wherein said router bit comprises a plurality of selectively detachable elements.

16. The router bit as recited in claim 15, wherein said elements are aligned with said principal axis.

17. The router bit as recited in claim 15, wherein said elements are mutually secured by an elongated axial element extending from a position in proximity with said lower portion to a position within said second cutter.

18. The router bit as recited in claim 15, wherein said elements are mutually secured by an elongated axial element extending from within said second cutter to a point in proximity with said lower portion.

19. The router bit as recited in claim 17, wherein said elongated axial element extends through at least one other element of said router.

20. The router bit as recited in claim 18, wherein said elongated axial element extends through at least one other element of said router.
